(19) United States
(12) Patent Application Publication
(10) Pub. No.: US 2002/0020438 A1
(43) Pub. Date: Feb. 21, 2002

(54) Molded adjustable crutch

(76) Inventor: Aaron R. Best, Ingleside, IL (US)

Correspondence Address: ROCKEY, MILNAMOW & KATZ, LTD., TWO PRUDENTIAL PLAZA, STE. 4700, 180 NORTH STETSON AVENUE, CHICAGO, IL, 60601, US

(21) Appl. No.: 09/832,636

(22) Filed: Apr. 11, 2001

Related U.S. Application Data
(60) Provisional application No. 60/196,719, filed on Apr. 13, 2000.

(51) Int. Cl. A61H 3/02

(52) U.S. Cl. 135/69; 135/68

(57) ABSTRACT

An inexpensive molded crutch has a single point adjustment mechanism for length and handle location relative to the ends of the crutch. The body of the crutch can be molded of a curable high strength inexpensive resin in two parts. The two parts telescopingly engage one another to set an over-all length for the crutch. The handle can be slid along one of the sections of the body to an appropriate position relative to either end of the body. The three parts can be locked together by one or more laterally oriented fasteners or pins which pass through one or more openings in each of the molded crutch members.

This application claims the benefit of the earlier filed Provisional Application Ser. No. 60/196,719, filed Apr. 13, 2000.

### FIELD OF THE INVENTION

The invention pertains to crutches. More particularly, the invention pertains to adjustable and potentially relatively inexpensive crutches.

### BACKGROUND OF THE INVENTION

Crutches have been long been known and have been used by individuals who are recuperating from injuries to hips, legs, ankles or feet. Since users have a variety of physical characteristics, including height and arm length, known crutches which are usually implemented of wood or tubular aluminum provide adjustment in the over-all length of the crutch as well as relatively grip location.

In known crutches, a plurality of adjustment holes is provided in the tip end such that the over-all length can be altered, increased or decreased, by positioning the tip relatively to the body of the crutch. The tip is usually locked to the body of the crutch with a plurality of screws or other mechanical fasteners.

The grip or the handle can be positioned adjacent to one of a plurality of holes in the crutch frame or body. One or more screws is extended through the body, through the handle or grip into the other side of the body or frame locking the two parts together.

Known crutches suffer from two long term and recurring defects. One problem with known crutches is their cost. Despite the fact that crutches have been available for many years, they are still expensive enough that they represent a significant cost to patients. Additionally, known crutches require two separate adjustments, one to adjust the over-all length as noted above and, a second to adjust the position of the grip relative to either end of the crutch.

There continues to be a need for improvements in crutches. Preferably, different materials might be used to promote cost reduction while at the same time providing adequate strength for usage of the crutches. In addition, it would be desirable to be able to move beyond two-point adjustment configurations to simplify and improve the fitting process. At the same time, improved fitting may well result in greater effectiveness and ease of use by patients than has heretofore been possible.

### SUMMARY OF THE INVENTION

A crutch with a single point adjustment has a two-part body which could be formed, for example, of wood, metal or cured resin. One part of the body has a tip formed thereon. The other part has a curved shoulder end. The two parts of the body slidably engage one another in a telescoping fashion to provide an adjustable axial length.

A handle or gripping element can be positioned on the body at a selected distance from, for example, the tip end. The grip or the handle is thereupon locked to the two-part body precluding relative movement among any of the parts of the body and the handle.

In one embodiment, one part of the body is hollow and slidably receives a portion of the second part of the body. The two parts of the body are axially movable relative to one another.

The portions of the body which include the two telescoping parts exhibit increased strength in response to applied lateral forces due to the presence of one part being received in the other. Preferably, the two parts have substantially identical cross sections at least in the region where they slidably engage one another. Representative cross sections include circular, elliptical, and polygons such as triangular, rectangular, square or other polygonal configurations.

The grip or handle, in one aspect of the invention, can be formed with two attached, axially oriented, hollow end sections each having an internal cross section compatible with an exterior cross section of one of the parts of the body. The handle can be slidably positioned on the body in accordance with the height and length of arms of the user.

In another aspect of the invention, one or more pins which can have a variety of cross sections can be inserted into the ends of the handle, as well as the two telescoped body sections thereby locking all three parts together and precluding relative motion therebetween. In another aspect of the invention, first and second pluralities of pins can be coupled through holes in the slidable end of the handle to engage corresponding holes or openings in the telescoped portions of the body of the crutch. Separate metal or plastic fasteners could also be used. All of these fasteners provide a single point adjustment for both length and handle location relative to either end of the crutch.

In one embodiment of the invention, the body parts and the handle can be molded of a curable resin such as 30 percent glass filled polypropylene. Such material, when cured, resists deflection and breakage and is very inexpensive. Alternately, other curable resins of sufficient strength, such as glass filled nylon, could also be used.

The molded body parts and handle can be over-molded with a 40-70 Durometer thermoplastic rubber. The over-molded material, which could be selected from a variety of commercially available moldable rubbers, is soft and deformable enough to provide a comfortable covering material for the handle as well as to form a cushion or pad at the shoulder end of one part of the body. Similarly, the thermoplastic rubber which is over-molded onto the tip end of the body can be expected to provide a non-slip gripping contact with the ground when the crutch is in use.

In another aspect of the invention, the two parts of the body as well as the handle can be molded in one or more colors in response to aesthetic requirements.

In another aspect of the invention, a method of fitting a crutch includes the steps of:

setting an over-all length of the crutch in response to physical characteristics of a user, without mechanically fixing the length for use;

positioning a handle on the crutch, relative to an end, in response to physical characteristics of the user, without mechanically fixing the handle for use; and

mechanically fixing the length and the handle to the crutch for use by means of at least one common fixing element.

In a further aspect, the fixing element can incorporate a plurality of common locking elements, such as a plurality of spaced apart pins. The pins can be laterally inserted into sliding sections of the handle as well as the two parts of the body of the crutch.

In yet another aspect of the invention, an adjustable crutch could be manufactured by a process which includes:

molding an upper body section;

molding a lower body section;

molding a core for a handle;

over-molding a pad on one end of the upper section;

over-molding a tip on one end of the lower section;

over-molding a comfortable covering on the core;

assembling the crutch by sliding the handle onto a free end of one of the sections of the body, slidably engaging free ends of the two sections of the body; and

inserting a common mechanical locking element to lock the handle as well as the two sections of the body together thereby precluding relative movement therebetween.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is an exploded view of a crutch in accordance with the present invention;

FIG. 2A is a front elevational view of a handle for the crutch of FIG. 1;

FIG. 2B is a side elevational view of the handle of FIG. 2A;

FIG. 3 is an enlarged, fragmentary, front elevational view of the handle of the crutch of FIG. 1 illustrating various relationships with the body members thereof;

FIG. 4 is a sectional view taken along plane 4-4 of FIG. 3;

FIGS. 5A and 5B are front elevational views of the crutch of FIG. 1 illustrating adjustment for different lengths;

FIG. 5C is a side elevational view of the crutch of FIG. 5B;

FIGS. 6A, 6B, 6C, and 6D are sectional views taken along plane 6-6 of FIG. 3; and

FIG. 7 is a front elevational view of an alternate embodiment of the crutch of FIG. 1.

### DETAILED DESCRIPTION OF THE PREFERRED EMBODIMENTS

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

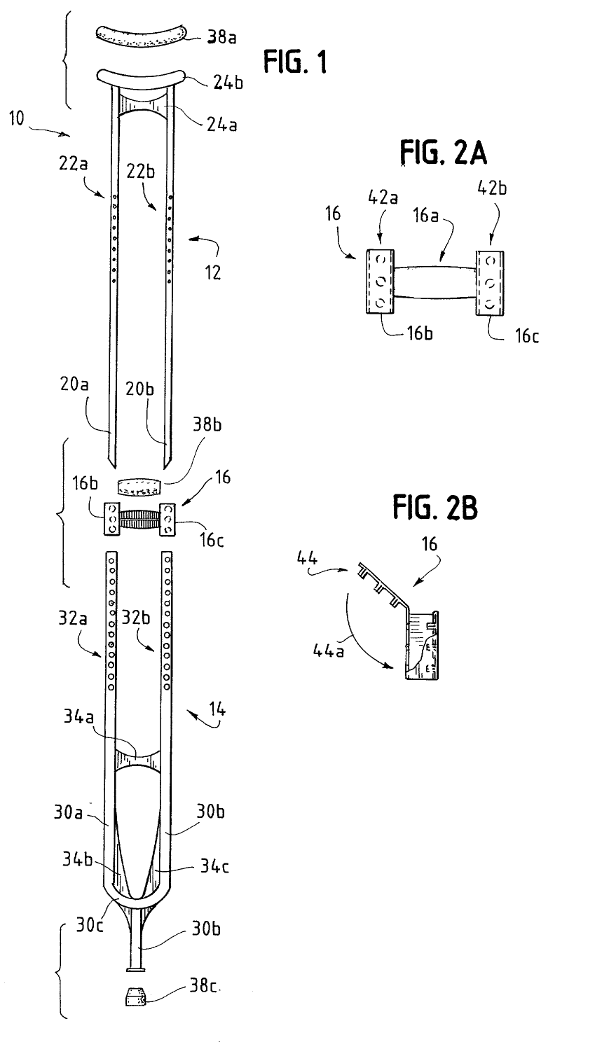

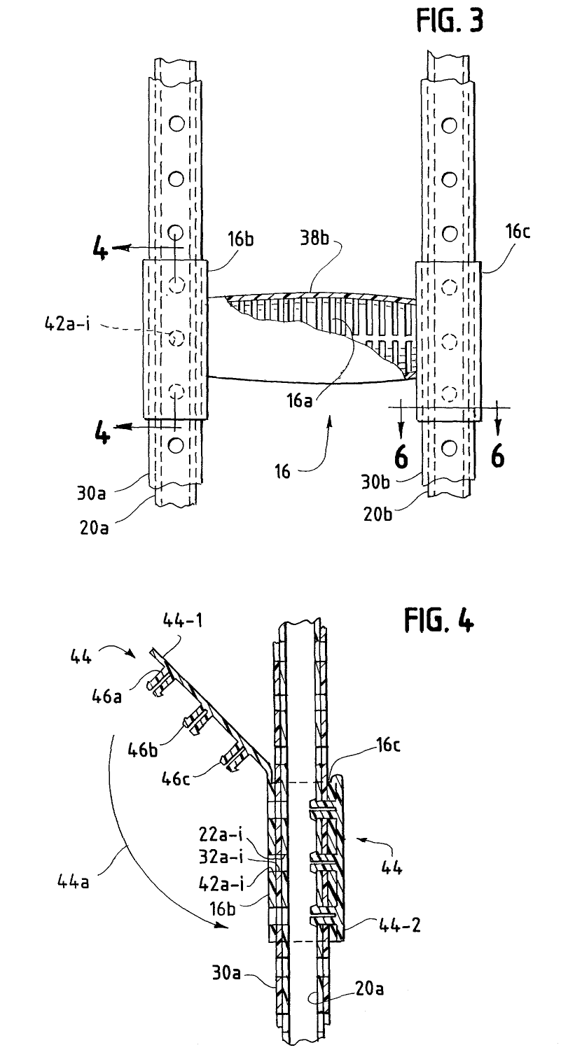

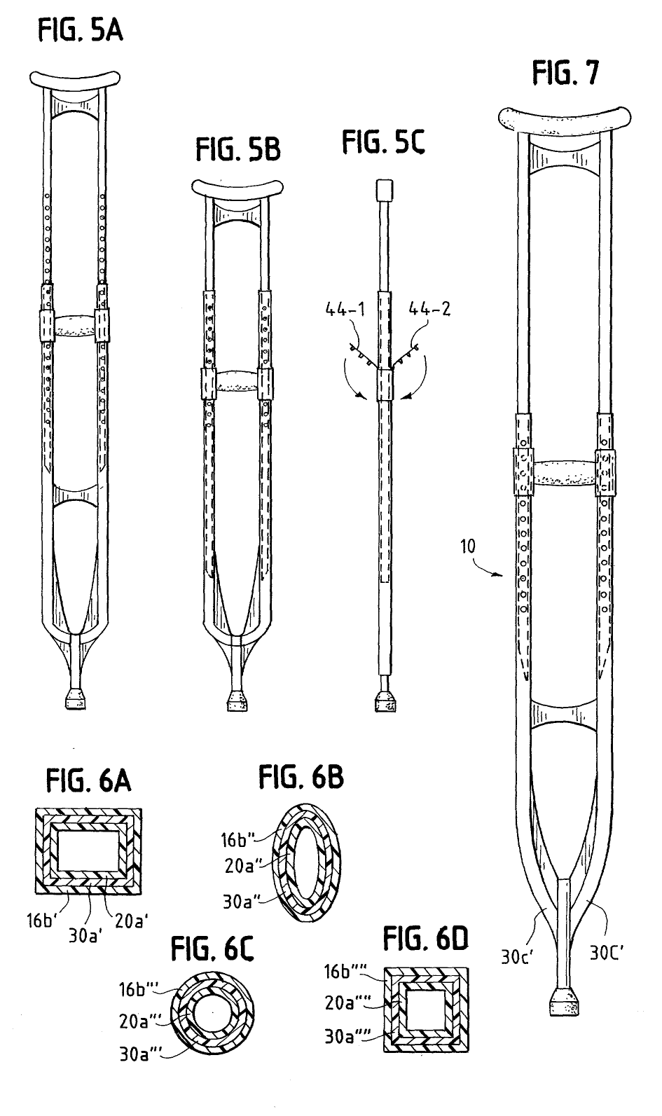

FIG. 1 is an exploded view of a crutch 10 in accordance with the present invention. The crutch 10 is formed of first and second body sections indicated generally at 12 and 14. A handle 16 is carried on a crutch 10, as discussed in more detail subsequently, oriented generally laterally with respect thereto.

In a preferred embodiment, body sections 12, 14 and handle 16 would all be injection molded using 30 percent glass filled polypropylene. This resin is not only strong but is relatively inexpensive.

The handle 16 is molded with a plurality of grooves 16a, best illustrated in FIG. 2A. Subsequent to molding the members 12, 14 and 16, each of them is over-molded in part, as explained below, with a commercially available thermoplastic rubber. Grooves 16a contribute to locking the over-molded rubber to handle 16.

Representative thermoplastic elastomers which are usable on the crutch 10 fall in a range of 40-70 Durometer. The preferred degree of softness is on the order of 50 Durometer.

Upper body section 12 is formed with first and second, spaced apart, elongated members 20a, 20b. The members 20a, 20b are molded with a plurality of openings therethrough indicated generally at 22a and 22b. As discussed in more detail subsequently, the openings 22a, b contribute to the implementation of a single point adjustment system for the crutch 10. The members 20a, b are joined by a laterally extending web 24a and a curved upper pad support 24b.

The lower body portion 14 is molded with first and second spaced apart, elongated, hollow side sections 30a, 30b. Each of the side sections 30a, 30b is perforated with a plurality of openings 32a and 32b. The side members 30a, b are joined by a curved lower member 30c along with an integrally formed stem 30d.

A laterally extending molded web 34ajoins the two side sections 32a, 32b. Additional molded webbing 34b and 34c joins the respective side members 30a, 30b to the curved region 30c.

Subsequent to the process of molding members 12, 14 and 16, each of them is over-molded, in part, with the above-noted thermoplastic rubber. In this regard, curved pad support 24b is over-molded with the elastomer to form a deformable comfort pad 38a. The handle 16 is over-molded with deformable cover 38b. Finally, stem 30d is over-molded with a tip 38c. Thus, the crutch 10 includes and is formed preferably of two different types of resins.

FIGS. 2A and 2B taken together illustrate additional details of handle 16. The handle 16 is formed of integrally molded side sections 16b and 16c, each of which is hollow. The side sections 16b, 16c have an internal cross section which corresponds to the exterior cross section of side sections 30a, 30b. Each of the side sections 16b, 16c includes a respective set of perforations or openings therethrough 42a and 42b. The spacing of the openings 42a, 42b is such that they line up with respective ones of the openings 22a, 22b and 32a, 32b of sections 12 and 14.

Handle 16 also carries integrally molded, hinged locking elements 44. Each of the elements 44 can be pivoted, 44a, into respective openings 42a, b of the side sections 16b, 16c. As discussed subsequently, elements 44 lock members 12, 14 and 16 together with a single point adjustment.

In addition to the side sections 16b, 16c sliding over side sections 30a, 30b, side sections 20a, b have an exterior cross section which corresponds to an interior cross section of hollow members 30a, b. Hence, body member 12 can be telescopingly received into body member 14 to provide for various over-all lengths of the crutch 10. Adjustment between one length and another of crutch 10 is based upon the openings 22a, b lining up with respective openings 32a, b of lower body section 14.

FIGS. 3 and 4 illustrate additional details of the interaction of handle 16 with side members 20a, b and 30a, b. As is illustrated therein, side sections 20a, b are slidably received within side sections 30a, b. The pluralities of openings 22a, b, 32a, b and 42a, b include members which line up, best illustrated in FIG. 4, in response to the relative positioning of side sections 20a, b relative to 30a, b and relative to handle 16. This alignment not only establishes an over-all length parameter for the crutch 10, it also locates handle 16 relative to either end thereof.

Two opposed latch structures 44-1 and 44-2, illustrated in FIG. 4, are carried on opposite sides of respective sections 16b, c. These structures rotate toward each other to engage aligned openings such as openings 22a-i, 32a-i and 42a-8 exhibited by the three-layer structure. This three-layer structure is formed of side sections 20a, b, 30a, b and 16b, c.

When extensions or pins, such as 46a, b, c slidably engage the respective aligned openings such as openings 22a-i, 32a-i and 42a-i, the length of crutch 10 and position of handle 16 thereon are permanently fixed. This thus provides a conveniently adjustable and inexpensive crutch assembly.

The crutch 10, when molded of 30 percent glass filled polypropylene can be expected to resist a lateral deflecting force on the order of 160 pounds located at the center of the respective crutch, irrespective of its length, when the crutch 10 is oriented at a 45° angle relative to the horizontal FIGS. 5A and 5B illustrate the relative locations of side members 20a, b and 30a, b along with handle 16 for various crutch lengths. FIG. 5C, a side view of the crutch of FIG. 5B illustrates integrally molded lock members 44-1 and 44-2.

As noted above, the interior cross section of handle sections 16b, 16c corresponds to the exterior cross section of side sections 30a, b. Additionally, an exterior cross section of side sections 20a, b corresponds to an interior cross section of side sections 30a, b.

FIGS. 6A, B, C and D illustrate alternative cross sectional configurations for the members 20a, b, 30a, b and 16b, c of the crutch 10. FIG. 6A illustrates a rectangular cross section wherein side section 30a′ is surrounded by handle side section 16b′. Side section 30a′ in turn surrounds side section 20a′. Other closed polygonal sections come within the spirit and scope of the present invention and may be used. Alternates include triangular, three-sided, cross sections as well as a pentagon, five-sided, cross section all without limiting the scope of the present invention. Circular or elliptical cross sections could also be used.

FIG. 7 illustrates a crutch 10′ with a curved end 30c′ having an alternate shape. Other variations come within the spirit and scope of the invention.

It will also be understood that while a preferred embodiment has been disclosed as being molded of a curable resin, alternate materials such as wood or metal could be used without departing from the spirit and scope of the present invention. All such alternate embodiments would exhibit single point adjustment not only of crutch length but also of handle position in accordance with the present invention.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. A crutch with a single point adjustment comprising:
a two-part body with a tip end, a shoulder end and an adjustable axial length;
a gripping element, positionable on the body at a selected distance from the tip end wherein the gripping element is locked to the two part body precluding relative motion among any of the parts of the body and the gripping element.

2. A crutch as in claim 1 wherein one part slidably receives a portion of the second part therein.

3. A crutch as in claim 1 wherein the two parts have substantially identical cross sections, at least in part, wherein the cross sections are dimensioned such that a portion of one part is slidably receivable in a portion of the second part.

4. A crutch as in claim 3 wherein the parts are hollow and the cross sections are selected from a class which includes a square cross section; a round cross section, an elliptical cross section, a triangular cross section, a rectangular cross section and a polygonal cross section wherein the polygon has at least four sides.

5. A crutch as in claim 1 which includes a connection element to lock the two parts and the gripping element together thereby precluding relative motion therebetween.

6. A crutch as in claim 2 which includes a connection element to lock the two parts and the gripping element together thereby precluding relative motion therebetween.

7. A crutch as in claim 5 wherein the connection element includes at least one locking pin to slidably engage the parts and the gripping element.

8. A crutch as in claim 6 wherein the connection element includes at least one locking pin to slidably engage the parts and the gripping element.

9. A crutch as in claim 7 which includes a plurality of laterally oriented locking pins wherein at least one member of the plurality moves in a first direction to a locking position and wherein at least one other member of the plurality moves opposite the first direction to a different locking position.

10. A crutch as in claim 8 which includes a plurality of laterally oriented locking pins wherein at least one member of the plurality moves in a first direction to a locking position and wherein at least one other member of the plurality moves opposite the first direction to a different locking position.

11. A crutch as in claim 1 wherein the parts of the body are substantially formed of at least one of metal, a hardened resin and wood.

12. A crutch as in claim 5 wherein the parts of the body are substantially formed of at least one of metal, a hardened resin and wood.

13. A crutch as in claim 6 wherein the parts of the body are substantially formed of at least one of metal, a hardened resin and wood.

14. A crutch as in claim 1 wherein the parts of the body comprise a cured, rigid plastic resin and wherein at least the tip end is covered at least in part with a deformable elastomer.

15. A crutch as in claim 14 wherein the gripping element is covered, at least in part, with a deformable elastomer.

16. A crutch as in claim 16 wherein the shoulder element is covered, at least in part, with a deformable elastomer.

17. A crutch as in claim 5 wherein at least one of the tip end, the shoulder end and the gripping element is covered, at least in part with a deformable elastomer.

18. A crutch as in claim 6 wherein at least one of the tip end, the shoulder end and the gripping element is covered, at least in part with a deformable elastomer.

19. A crutch as in claim 1 wherein the two parts telescopingly slide together for both length adjustment and to provide additional structural mass to resist deformation from laterally directed forces.

20. A method of fitting a crutch comprising:
setting an over-all length of the crutch, in response to physical characteristics of a user, without mechanically fixing same for use;
positioning a handle on the crutch, relative to an end, in response to physical characteristics of the user, without mechanically fixing same for use; and mechanically fixing the length and the handle to the crutch for use using at least one common fixing element.

21. A method as in claim 20 which includes inserting a plurality of common locking elements into the crutch.

22. A method as in claim 21 which includes inserting first and second pluralities of opposed common locking elements into the crutch.
